(19) United States
(12) Patent Application Publication
(10) Pub. No.: US 2004/0145684 A1
(43) Pub. Date: Jul. 29, 2004

(54) Portable video unit comprising an electronic console such as video reader or a play station, and an associated independent screen

(76) Inventors: Pascal Albert, Rue de Luxembourg (LU); Gilbert Jost, Rue Haard (LU)

Correspondence Address: YOUNG & THOMPSON, 745 SOUTH 23RD STREET 2ND FLOOR, ARLINGTON, VA, 22202

(21) Appl. No.: 10/376,275

(22) Filed: Mar. 3, 2003

(30) Foreign Application Priority Data
Jan. 28, 2003 (FR) 03 00938

(51) Int. Cl. H04N 7/18

(52) U.S. Cl. 348/837; 725/75

(57) ABSTRACT

This invention concerns a video unit, intended for a seat, with a video set comprising an electronic console (5), such as a video reader or a play station, and an associated independent screen (7), which unit comprises moreover—a connection means (11) intended for the electric supply of said video unit, and—an interconnection means (12) for the audio-video link between said console and said screen.

This unit comprises a supporting structure (4) in the form of a seat protective cover, fitted on its portion intended to cover the rear face of said seat, with at least one means for receiving said electronic console (5), and possibly a means for receiving the associated screen (7).

This invention concerns a complete video unit, intended to be installed on the rear face of a seat, notably a vehicle seat, and composed of a supporting structure associated with a video unit comprising—an electronic console, as a DVD, a SVCD, a VCD reader, a play station or other, and, an independent screen, such as a liquid s crystal display, a cathodic, a plasma screen or other.

The head-rests or the upper sections of the seat backs of automotive vehicles, trains, even airplanes, are sometimes fitted with a video screen enabling the person sitting behind the seat thus fitted, for example to view a film or to view commercial adverts.

The cushions forming the back or the head-rest of the seat are generally composed of a block of synthetic foam with a protection cover made of flexible material. They are structured and prepared in such a way as to receive, in fine, the video screen; in particular, they comprise a housing for embedding the screen and an integral fastening stand.

However, these particularities make the manufacture of the corresponding cushions significantly more difficult, notably because of the necessity to provide internal fastening means, and also because of the particular preparation of the protection cover necessary to accommodate the video unit and to obtain good quality finish. In all cases, the cushions must be designed or modified specifically to enable adaptation of the video unit.

The purpose of this invention to provide a video unit of original design, comprising a supporting structure which ensures quick and aesthetic fastening to the cushions forming the seat. The video unit according to the invention enables moreover minimum space requirements, with respect to the added-on video units known until now.

The video unit according to the invention comprises a supporting structure in the form of a seat protective cover, fitted on its portion intended to cover the rear face of said seat, with at least one means for receiving the electronic console of said video unit.

By ‘receiving means’ is meant notably any adapted structure enabling interconnection between the electronic console and the supporting structure in the form of a protective cover. For example, this receiving means can be a pocket arranged on the external face of the seat back and adapted to contain the electronic console; the receiving means may also consist of a rigid structure forming a housing for receiving the electronic console, whereas the console and its adapted housing are interlocked by adapted additional members.

According to a first embodiment, the video unit comprises a supporting structure accommodating the screen with its front face visible, independent of the supporting structure accommodating the electronic console.

According to this variation, the video unit comprises on the one hand, a supporting structure in the form of a protective cover for a head-rest fitted with a screen receiving means arranged on its section intended to cover the rear face of said head-rest, and, on the other hand, a supporting structure in the form of a protective cover for seat backs, fitted with a console receiving means fitted on its section intended to cover the rear face of said seat back.

According to a second variation, the video unit comprises a supporting structure in the form of a protective cover comprising, on its section intended to cover the rear face of the seat, a second means enabling to receive the screen with its front face visible.

According to a first embodiment of this variation, the supporting structure consists of a protective cover intended for the back section of said seat. Preferably, the screen receiving means lies in a higher position relative to the electronic console receiving means.

According to a second embodiment of this variation, the supporting structure consists of a single block protective cover intended simultaneously for the head-rest section and the back section of the seat. Preferably, the screen receiving means is arranged on the section of said cover intended for the rear face of the head-rest, and the receiving means of said electronic console is arranged on the section of said cover intended for the back section of the seat.

Still according to a variation of the invention, the supporting structure consists of a seat back cover and/or a head-rest cover fitted with a receiving means for an electronic console and an adjoining screen, which means delineates a single receiving space.

Still according to the invention, the video set comprises a supporting structure in the form a of cover fitted with at least one screen receiving means and/or an electronic console receiving means interconnected with said protective cover by removable fastening means.

Still according to the invention, the video unit comprises at least—one power supply socket from which extends an internal power supply cabling intended for the electric supply of the video unit, and—an internal cabling system for the audio-video link between said console and said screen.

Still according to the invention, the video unit comprises means enabling removable fastening of the electronic device(s) of the video unit within their receiving means.

Still according to the invention, the video unit integrates at least one receiving device connected to the electronic console, enabling its operation by an adapted transmitter-type device.

Still according to the invention, the video unit integrates at least one transmitter and/or video-type device, enabling to use an adapted receiving device, such as a cordless headset.

The video unit according to the invention still comprises advantageously a supporting structure fitted with means enabling to fasten accessory elements of the video unit, such a remote control a headset or other.

Still according to the invention, the video unit comprises a supporting structure fitted—with an additional power supply connection socket, as well as—at least one audio-video connection socket, which sockets are connected to the internal cabling system for external power supply of a screen and/or an appended electronic console.

The purpose of the invention is also a supporting structure in the form of a protective cover for seats, as described above.

But the invention will be better illustrated, without being limited thereto, by the following description of various embodiments, given solely for exemplification purposes and represented on the appended drawings wherein:

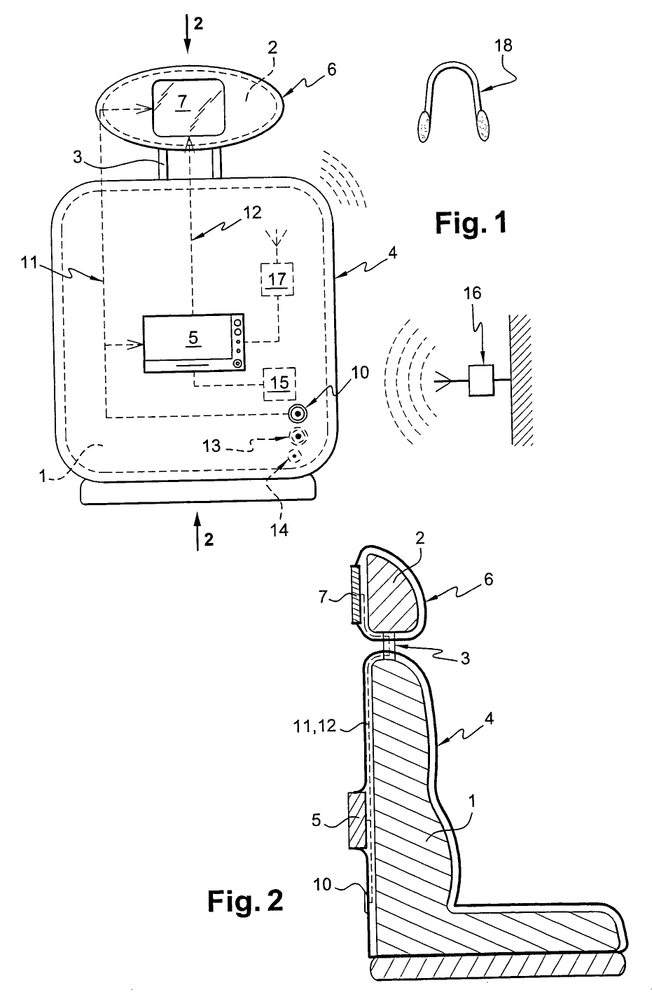

FIG. 1 is a schematic view of the rear face of a vehicle seat, fitted with a video unit according to the invention, consisting here of a seat protective cover accommodating the electronic console and a head-rest protective cover accommodating the screen;

FIG. 2 is a sectional view along 2-2 of the seat fitted with the video unit represented on FIG. 1;

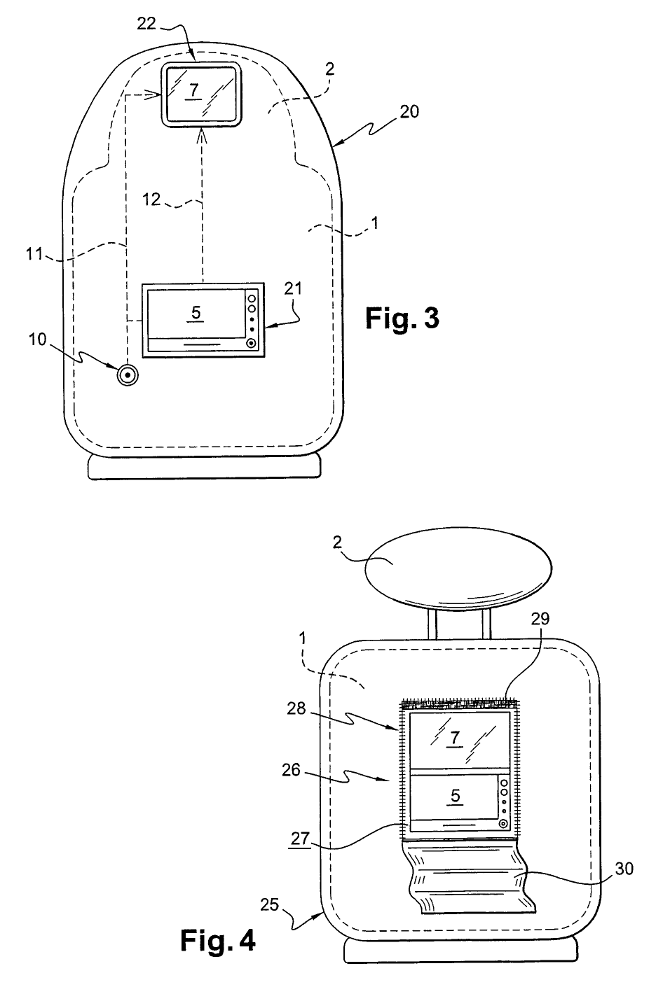

FIG. 3 is a schematic representation of the rear face of a seat fitted with a video unit according to the invention, whereas the supporting structure in the form of a protective cover is a single block;

FIG. 4 is a schematic representation of the rear face of a seat fitted with a video unit according to the invention, whereof the supporting structure in the form of a seat back protective cover is fitted with a single receptacle for receiving the video unit.

FIG. 1 represents a seat fitted with a video unit according to the invention. This seat consists of a seat back 1 extended by an independent head-rest 2 and fixed by anchoring rods 3.

This seat is fitted with a video unit composed on the one hand, of a supporting structure 4 in the form of a back seat protective cover whereof the section covering the rear face of said back comprises an electronic console 5 with its front face visible, and on the other part, of a supporting structure 6 in the form of head-rest 2 protective cover whereof the section covering the rear face of said head-rest 2 comprises a screen 7 with its front face visible. The supporting structure 4 accommodating the electronic console 5 is therefore independent of the supporting structure 6 accommodating the screen 7.

The video unit may for example consist of a DVD assembly consisting of DVD reader and of its associated screen, enabling to view DVDs.

The supporting structures 4, 6 are shaped to match as much as possible the contours of the seat back 1 and of the head-rest 2. Each of them comprises an opening which enables their positioning on the section of the seat for which they are intended.

Preferably, the protective cover 6 structure intended to cover the head-rest 2 is fitted with removable closing members such as elastics or self-gripping bands: the protective cover structure 4 intended for the seat back 1 is associated with interconnection members such as hooks, straps or others, to be attached to the chassis of the seat.

The electronic devices 5, 7 of the video unit are attached to their supporting structure 4, 6 by any appropriate means.

For solely informative purposes, an opening or a cut-out may be provided in the section of the protective covers 4, 6 intended for the rear face of the seat back 1 and of the head-rest 2, and whereof the form and the dimensions are adapted to the electronic console 5 and to the screen 7; then, the electronic devices 5, 7 can be sandwiched, using the peripheral rim of said openings, between the electronic device and a complementary added-on rigid structure, placed on the internal face side of the protective cover 4, 6. This fastening can be of the removable type by means of additional members provided between said electronic devices 5, 7 and the additional rigid structures.

The electric connections enabling the operation of the video unit are represented schematically as a dotted line on FIG. 1.

Any cabling for the power supply of the console 5 and the screen 7 are preferably laid out on the internal face of the supporting structures 4, 6. They can run between the back seat 1 and the head-rest 2 while hugging one of the anchoring rods 3 of the head-rest 2.

One can note on FIG. 1 the presence of a power supply connection socket 10, arranged on the supporting structure 4 covering the seat back 1. Obviously, this socket 10 can be positioned in any position on the video unit, for example on the electronic console 5.

This power supply connection socket 10 enables to connect the unit to the mains or to the cigarette-lighter socket of an automotive vehicle, by means of an adapted connection cord. The integrated cables 11 power supplying the console 5 and the screen 7 extend from this connection socket 10.

On the other hand, the console 5 and the screen 7 are linked by a cabling 12 intended for the audio-video link between both these devices.

The video unit may also integrate, as represented as a doted line on FIG. 1,—an additional power supply connection socket 13, and—an audio-video connection socket 14; these sockets 13, 14 enable power supply and operation from outside the screen 7 fitting either the head-rest 2 extending the seat back 1, FIG. 1, or the head-rest of an adjoining seat (not illustrated).

This unit also integrates a receiver-type device 15 connected to the electronic console 5; this receiver 15 enables notably to operate the console 5 by means of an external transmitting device 16 of the information transmitting station type, for example.

This video unit integrates moreover an audio-video transmitting device 17, connected to the video unit; this transmitter 17 enables to use a cordless audio-video receiver-type device 18, for example of the audio headset type.

For easier stowing of all these accessories (remote control and audio headset), fastening and stowing means can be provided on the receiving protective cover of the video unit.

According to an alternate embodiment of the invention represented on FIG. 3, the video unit comprises a supporting structure in the form of a single block protective cover for the seat back 1 and the head-rest 2 of the seat simultaneously.

This single block protective cover 20 is fitted with two receptacles 21, 22. One of said receptacles 21 is provided on the section of said protective cover 20 for the rear face of the seat back 1 in order to accommodate the electronic console 5 with its front face visible, the other of said receptacles 22 is arranged on the section of the protective cover 20 for the rear face of the head-rest 2 in order to accommodate the screen 7.

The whole cabling 11, 12 adapted for the operation of the unit is provided preferably on the internal face of the supporting structure 20.

Obviously, this video unit may also integrate any additional accessory, such as a transmitting and/or a receiving device, to improve notably its use and its ergonomics.

FIG. 4 represents further a variation of a video unit according to the invention, comprising a supporting structure 25 in the form of a protective cover for seat back 1 fitted, on its section intended to cover the rear face of said back 1, with an intermediate receptacle 26 adapted to contain the video unit 5, 7. The video unit 5, 7 exhibits here the form of a single block assembly, whereas the console 5 and the screen 7 are linked by a hinged system.

This intermediate receptacle 26 is delineated by a bottom 27 and by a belt of lateral walls 28. It is interconnected on the supporting structure 25 by any appropriate means For example, the bottom 27 can be sewed or glued on said supporting structure 25 removably, by means of self-gripping bands or of a zip fastener for example.

This receptacle 26 is made of flexible material, for example fabric or synthetic material. The lateral walls 28 may be reinforced by the implementation of a rigid belt against the internal face of said walls.

The video unit 5, 7 is interconnected within the intermediate receptacle 26 by any adapted means. For solely informative purposes, the bottom 27 of the receptacle 26 is fitted with a self-gripping band intended to co-operate with an additional band provided on the rear face of the console 5; the receptacle 26 is also fitted with an elastic band 29 intended to hug the upper end of the screen 7. It is then possible to integrate or to withdraw the video unit rapidly 5, 7 of the intermediate receptacle 26.

Besides, this receptacle 26 is fitted with a flap 30, to close its front face. This flap 30 is fitted with a system enabling removable closing of the receptacle 26, for example of the zip fastener type.

These different video units, comprising supporting structures in the form of seat back, head-rest or single block protective covers, can be installed on the receiving seats quite conventionally.

All these units enable minimum space requirements when used, and allow adaptation over a wide range of vehicle seats.

1.- A video unit, intended for a seat, with a video set comprising an electronic console (5), such as a video reader or a play station, and an associated independent screen (7), which unit comprises moreover—a connection means (11) intended for the electric supply of said video unit, and—an interconnection means (12) for the audio-video link between said console (6) and said screen (7),
characterised in that it comprises a supporting structure (4, 20, 25) in the form of a seat protective cover, fitted on its portion intended to cover the rear face of said seat, with at least one means for receiving said electronic console (5).

2.- A video unit according to claim 1, characterised in that it comprises a supporting structure (6) accommodating the screen (7) with its front face visible, which supporting structure (6) is independent of the supporting structure (4) accommodating the electronic console (5).

3.- A video unit according to claim 2, characterised in that it comprises on the one hand, a supporting structure (6) for the screen (7) consisting of a protective cover for a head-rest (2) fitted with a means for receiving said screen (7) arranged on its section intended to cover the rear face of said head-rest, and, on the other hand, a supporting structure (4) for the electronic console (5) consisting of a protective cover for seat backs (1), fitted with a means for receiving said console (5), arranged on its section intended to cover the rear face of said seat back.

4.- A video unit according to claim 1, characterised in that it comprises a supporting structure (20) in the form of a protective cover comprising, on its section intended to cover the rear face of the seat, a second means (22) enabling to receive the screen (7) with its front face visible.

5.- A video unit according to claim 4, characterised in that the supporting structure consists of a protective cover intended for the back section of said seat, which protective cover is fitted with the means for receiving the screen in a higher position relative to the electronic console receiving means.

6.- A video unit according to claim 4, characterised in that the supporting structure (20) consists of a single block protective cover intended simultaneously for the head-rest section (2) and the back section (1) of the seat, whereas the receiving receptacle (22) of the screen (7) is arranged on the section of said cover (20) intended for the rear face of the head-rest (2), and the receiving receptacle (21) for said electronic console (5) is arranged on the section of said cover (20) intended for the back section (1) of the seat.

7.- A video unit according to claim 1, characterised in that it comprises a supporting structure (25) in the form of a seat back cover and/or a head-rest cover fitted with a receiving receptacle (26) for an electronic console (5) and an adjoining screen (7), which receiving receptacle (26) delineates a single receiving space.

8.- A video unit according to any of the claims 1 to 7, characterised in that it comprises a supporting structure in the form a of seat protective cover fitted with at least one receiving means interconnected with said protective cover by removable fastening means.

9.- A video unit according to any of the claims 1 to 8, characterised in that it comprises at least—one power supply socket (10) from which extends an internal power supply cabling (11) intended for the electric supply of the video unit (5, 7), and—an internal cabling system (12) for the audio-video link between said console (5) and said screen (7).

10.- A video unit according to any of the claims 1 to 9, characterised in that it comprises receiving means enabling removable fastening of the electronic device(s) of the video unit within their corresponding supporting structure.

11.- A video unit according to any of the claims 1 to 10, characterised in that it integrates at least one receiving device (15) connected to the electronic console, enabling its operation by an adapted transmitter-type device.

12.- A video unit according to any of the claims 1 to 11, characterised in that it integrates at least one transmitter and/or video-type device (17), enabling to use an adapted receiving device (18), such as a cordless headset.

13.- A video unit according to any of the claims 1 to 12, characterised in that it comprises a supporting structure fitted with means enabling to fasten accessory elements of the video unit, such a remote control, a headset or other.

14.- A video unit according to any of the claims 1 to 13, characterised in that it comprises a supporting structure fitted—with an additional power supply connection socket (13), as well as—at least one audio-video connection socket (14), which sockets (13, 14) are connected to the internal cabling system (11, 12) for external power supply of a screen and/or an independent electronic console.

15.- A supporting structure in the form of a protective cover for a seat back, intended to accommodate at least one electronic device (5, 7) of a video set, according to any of the claims 1 to 14.
